(19) United States
(12) Patent Application Publication
(10) Pub. No.: US 2015/0343908 A1
(43) Pub. Date: Dec. 3, 2015

(54) MULTI-PHASE POWER SYSTEM

(71) Applicant: Caterpillar Global Mining Equipment LLC, South Milwaukee, WI (US)

(72) Inventor: Saeid Mirzaei, Muskego, WI (US)

(73) Assignee: Caterpillar Global Mining Equipment LLC, South Milwaukee, WI (US)

(21) Appl. No.: 14/290,331

(22) Filed: May 29, 2014

(51) Int. Cl. B60L 11/04; B60R 16/03; B60L 1/00

(52) U.S. Cl. CPC B60L 11/04; B60L 1/00; B60R 16/03

(57) ABSTRACT

Mining vehicles and power systems for use with such vehicles are provided. One power system includes a synchronous generator circuit configured to generate an alternating current (AC) power signal distributed across at least six phases. The power system further includes a rectifier circuit including at least twelve diode devices and configured to receive the AC power signal distributed across the at least six phases from the synchronous generator circuit and generate a direct current (DC) power output signal. The DC power output signal includes at least twelve pulses for a single wave of the AC power signal received from the synchronous generator circuit. The rectifier circuit is configured to output the DC power output signal for use in powering a load device of the mining vehicle.

### TECHNICAL FIELD

This disclosure relates generally to power systems for mining vehicles. More specifically, various embodiments of the disclosure relate to multi-phase alternator circuits for powering various components of a mining vehicle.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Heavy machinery, such as off-highway trucking equipment, is commonly used in mining, heavy construction, quarrying, and other applications. Due to the substantial capital investment involved, tight tolerances with respect to the time allotted for completing tasks, and the expense of maintaining and operating heavy machinery, such as a mining truck, an entity can suffer significant monetary losses when the heavy machinery malfunctions. The complexity of modern heavy machinery often exacerbates this problem due to the need for skilled personnel to perform various tests on such machinery to trouble shoot such malfunctions.

One advance that has improved efficiency associated with the use of heavy machinery is the adoption of electric drive systems. Electric drive systems typically require less maintenance and thus, have lower life cycle costs. One such system is discussed in U.S. Pat. No. 6,198,238, which purports to disclose “[a]n electrical generator, consisting of a high phase order generator and a high phase order cycloconverter.” (U.S. Pat. No. 6,198,238, abstract.)

However, electric drive systems can still experience failures. For example, in some instances, DC-link capacitors configured to store output power from an alternator and rectifier (e.g., an electric power source) of a mining vehicle may experience failures due to issues such as high temperatures and/or vibration. In some instances, a rectifier configured to convert alternating current (AC) power received from a generator into direct current (DC) output power may experience failures due to issues such as shorted diodes and/or arc damage. In still further instances, the cables used to transmit AC power to the rectifier may be damaged. Each of these failures may cause substantial downtime and/or expense for the entity relying upon the heavy equipment.

### SUMMARY

One embodiment of the disclosure relates to a power system for a mining vehicle. The power system includes a synchronous generator circuit configured to generate an alternating current (AC) power signal distributed across at least six phases. The power system further includes a rectifier circuit including at least twelve diode devices and configured to receive the AC power signal distributed across the at least six phases from the synchronous generator circuit and generate a direct current (DC) power output signal. The DC power output signal includes at least twelve pulses for a single wave of the AC power signal received from the synchronous generator circuit. The rectifier circuit is configured to output the DC power output signal for use in powering a load device of the mining vehicle.

Another embodiment relates to a mining vehicle that includes at least one load device configured to perform one or more functions of the mining vehicle. The mining vehicle further includes a synchronous generator circuit configured to generate an alternating current (AC) power signal distributed across at least six phases. The mining vehicle further includes a rectifier circuit including at least twelve diode devices and configured to receive the AC power signal distributed across the at least six phases from the synchronous generator circuit and generate a direct current (DC) power output signal. The DC power output signal includes at least twelve pulses for a single wave of the AC power signal received from the synchronous generator circuit. The rectifier circuit is configured to output the DC power output signal for use in powering the at least one load device.

Another embodiment relates to a power system for a mining vehicle. The power system includes a synchronous generator circuit configured to generate an alternating current (AC) power signal distributed across six phases. The synchronous generator includes a first three-phase alternator module including a first set of three windings connected at a first common terminal in a wye configuration and a second three-phase alternator module including a second set of three windings connected at a second common terminal in the wye configuration. The second common terminal is different from the first common terminal, and each winding in the second set of three windings has a predetermined phase offset from a winding in the first set of three windings. The power system further includes a rectifier circuit including twelve diode devices and configured to receive the AC power signal distributed across the six phases from the synchronous generator circuit and generate a direct current (DC) power output signal. The DC power output signal includes twelve pulses for a single wave of the AC power signal received from the synchronous generator circuit. The rectifier circuit is configured to output the DC power output signal for use in powering one or more drive motors of the mining vehicle.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is an illustration of a front view of a mining vehicle according to an exemplary embodiment.

FIG. 2 is an illustration of a side view of the mining vehicle shown in FIG. 1 according to an exemplary embodiment.

FIG. 3 is a block diagram of an electric drive system for a mining vehicle according to an exemplary embodiment.

FIG. 4 is a schematic diagram of an electric drive system for a mining vehicle according to an exemplary embodiment.

FIG. 5 is a schematic diagram of a three-phase power system for a mining vehicle according to an exemplary embodiment.

FIG. 6 is a graph illustrating a voltage waveform of each of the three phases of the alternator shown in FIG. 5 according to an exemplary embodiment.

FIG. 7 is a graph illustrating a DC output voltage of the six-pulse rectifier circuit shown in FIG. 5 according to an exemplary embodiment.

FIG. 8 is a graph focused on a portion of the voltage range shown in FIG. 7 illustrating the DC output voltage of the three-phase power system shown in FIG. 5 in greater detail and illustrating a ripple voltage associated with the output according to an exemplary embodiment.

FIG. 9 is a schematic diagram of a power system for a mining vehicle having a generator and a rectifier in a same housing or in housings coupled to one another according to an exemplary embodiment.

FIG. 10A is an illustration of a front view of the power system of FIG. 9 according to an exemplary embodiment.

FIG. 10B is an illustration of a side view of the power system of FIG. 9 according to an exemplary embodiment.

FIG. 11A is a schematic illustration of a portion of a six-phase synchronous generator circuit according to an exemplary embodiment.

FIG. 11B is an illustration of a winding configuration of the six-phase synchronous generator circuit shown in FIG. 11A according to an exemplary embodiment.

FIG. 12 is a graph illustrating total harmonic distortion in various characteristics of a three-phase power system and a six-phase power system according to an exemplary embodiment.

FIG. 13 is a schematic diagram of a six-phase power system for a mining vehicle according to an exemplary embodiment.

FIG. 14 is a graph illustrating a voltage waveform of each of the six phases of the alternator shown in FIG. 13 according to an exemplary embodiment.

FIG. 15 is a graph illustrating a DC output voltage of the twelve-pulse rectifier circuit shown in FIG. 13 according to an exemplary embodiment.

FIG. 16 is a graph focused on a portion of the voltage range shown in FIG. 15 illustrating the DC output voltage of the six-phase power system shown in FIG. 13 and the three-phase power system shown in FIG. 5 in greater detail and illustrating a ripple voltage associated with the output according to an exemplary embodiment.

FIG. 17 is a schematic diagram of a nine-phase power system for a mining vehicle according to an exemplary embodiment.

FIG. 18 is a graph illustrating a voltage waveform of each of the nine phases of the alternator shown in FIG. 17 according to an exemplary embodiment.

FIG. 19 is a graph illustrating a DC output voltage of the 18-pulse rectifier circuit shown in FIG. 17 according to an exemplary embodiment.

FIG. 20 is a graph focused on a portion of the voltage range shown in FIG. 19 illustrating the DC output voltage of the nine-phase power system shown in FIG. 17, the six-phase power system shown in FIG. 13, and the three-phase power system shown in FIG. 5 in greater detail and illustrating a ripple voltage associated with the output according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, mining vehicles and power systems for powering various components of such vehicles are shown according to exemplary embodiments. Electric drive systems for mining vehicles, such as large vehicles designed to haul materials to and/or from a mining site, can experience a variety of failures. For example, DC bus capacitors may fail due to temperature and/or vibration-related issues. In some instances, temperature-related problems for such DC bus capacitors, and the cost of repairing and/or replacing such capacitors, may increase as the size of the capacitors increases due to high DC bus currents. In some instances, rectifiers and/or components thereof may fail. For example, diodes of a rectifier may be damaged due to electrical arcs (e.g., as a result of high voltages across the diodes with moisture and/or contamination) and/or may experience electrical shorts leading to very high currents through the diodes. In still further examples, cables carrying AC power from a generator to a rectifier may be damaged, causing one of the phases to be lost, which in turn may cause a decrease in the efficiency of the power system and/or failure of one or more of the load devices powered by the power system to perform its dedicated function(s).

Various embodiments of the present disclosure are configured to provide power systems for mining vehicles that have improved reliability and quality. In some embodiments, a power system may enclose a rectifier and generator within a same housing, or may enclose the components within housings that are coupled to one another. This may reduce or eliminate external AC cables to transmit power from the generator to the rectifier, which may be damaged and require repair or replacement, and may reduce a number of cables going from the power system (e.g., the rectifier) to an inverter cabinet of the mining vehicle to only two cables.

In some embodiments, a power system may include a generator circuit configured to generate AC power distributed over at least six phases. The power system may also include a rectifier circuit including at least twelve diode devices and configured to generate a DC power output signal based on the six-phase AC power signal from the generator circuit. The DC power output signal generated by the rectifier circuit includes at least twelve pulses for a single wave of the AC power signal received from the generator circuit. The relatively high number of pulses in the output signal may help reduce a ripple voltage of the output signal (e.g., an instability in the DC output voltage level). Distributing the input current across at least twelve diodes may allow for the use of diodes having a reduced size (e.g., as compared to a three-phase, six-diode system). In some implementations, some components may be reduced in size or eliminated, which may decrease both the initial cost of the power system and maintenance costs associated with component failures. In some embodiments, the power system may include a six-phase synchronous generator circuit with a twelve-diode rectifier circuit configured to generate a twelve-pulse output for each full wave of the AC input. In some embodiments, the power system may include a nine-phase synchronous generator circuit with an eighteen-diode rectifier circuit configured to generate an eighteen-pulse output for each full wave of the AC input. In other embodiments, power systems having additional phases and/or pulses may be utilized.

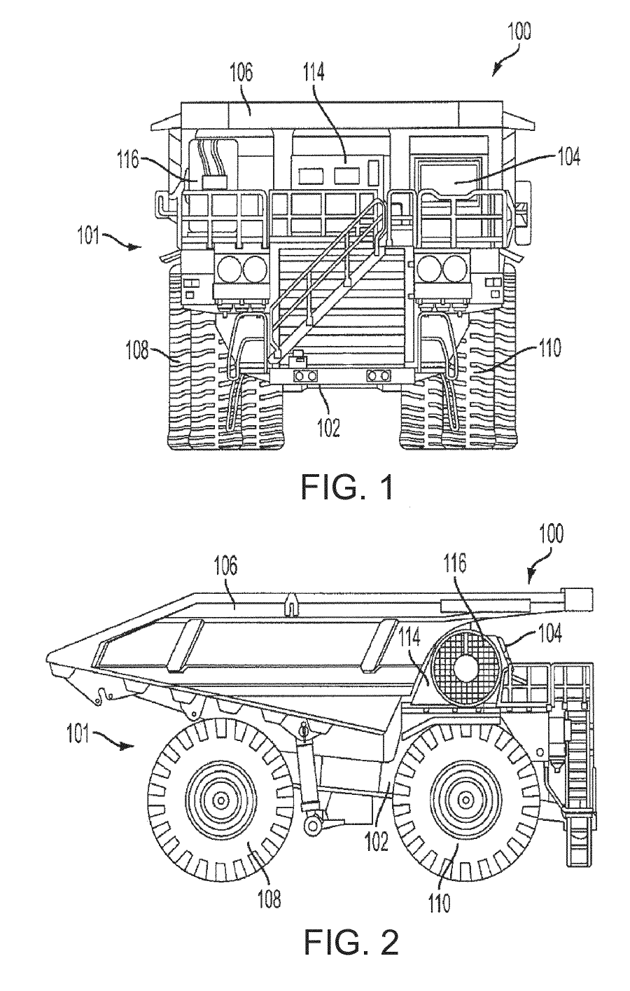

FIG. 1 and FIG. 2 illustrate, respectively, a front and a side view of a machine 100 according to an exemplary embodiment. The machine 100 is a direct series electric drive machine. One example of machine 100 is an off-highway truck 101 such as those used for construction, mining, or quarrying. Electrical power may be generated onboard by a generator, alternator, or another power-generation device, each of which may be driven by an engine or other prime mover. While machine 100 is provided for purposes of illustration, it should be understood that, in various embodiments, the power systems described herein may be utilized with various types of machines having characteristics different from those described with respect to machine 100.

A front view of off-highway truck 101 is shown in FIG. 1, and a side view is shown in FIG. 2. Off-highway truck 101 includes a chassis 102 that supports an operator cab 104 and a bucket 106. Bucket 106 is pivotally connected to chassis 102 and is arranged to carry a payload when off-highway truck 101 is in service. An operator occupying operator cab 104 can control the motion and the various functions of off-highway truck 101. Chassis 102 supports various drive system components. These drive system components are capable of driving a set of drive wheels 108 to propel off-highway truck 101. A set of idle wheels 110 can steer such that off-highway truck 101 can move in any direction. Even though off-highway truck 101 includes a rigid chassis with powered wheels for motion and steerable wheels for steering, one can appreciate that other machine configurations can be used. For example, such configurations may include articulated chassis with one or more driven wheels.

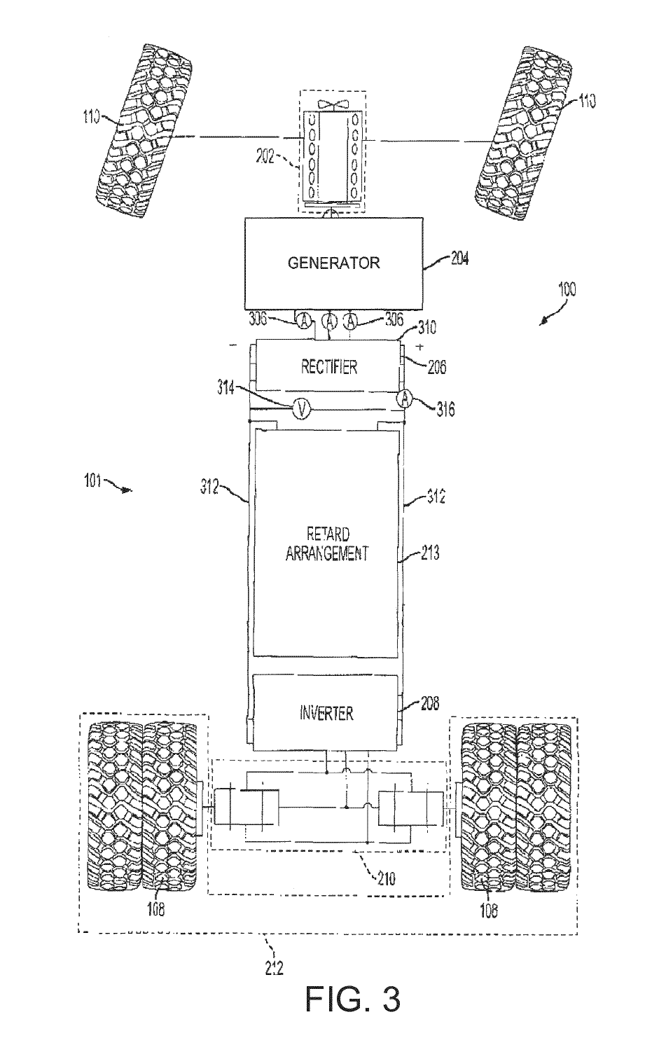

A block diagram for the electric drive system of machine 100, for example, off-highway truck 101, is shown in FIG. 3 according to an exemplary embodiment. The electric drive system includes an engine 202, for example, an internal combustion engine such as a diesel engine, which produces an output torque at an output shaft. The output shaft of engine 202 is connected to a generator 204. In operation, the output shaft of engine 202 may rotate a rotor of generator 204 to produce electrical power, for example, in the form of alternating current (AC) power. This electrical power is supplied to a rectifier 206 and converted to direct current (DC) power. The rectified DC power may be converted again to an AC power by an inverter circuit 208. Inverter circuit 208 may be capable of selectively adjusting the frequency and/or pulse-width of its output, such that motors 210 that are connected to an output of inverter circuit 208 may be operated at variable speeds. Motors 210 may be connected via final assemblies (not shown) or directly to drive wheels 212 of machine 100.

When off-highway truck 101 is propelled, engine 202 generates mechanical power that is transformed into electrical power, which is conditioned by various electrical components. In an illustrated embodiment, such components are housed within one or more housings, such as an inverter cabinet 114 (FIG. 1). Cabinet 114 is disposed on a platform that is adjacent to operator cab 104 and may include rectifier 206, inverter circuit 208, and/or other components. In some embodiments, when off-highway truck 101 is to be decelerated or its motion is otherwise to be retarded, for example, to prevent acceleration of the machine when travelling down an incline, its kinetic energy may be converted to electrical energy. Effective dissipation of this generated electrical power enables effective retarding of off-highway truck 101. Dissipation of the electrical power may be performed using a retard arrangement 213, which may dissipate the electrical power using, for example, one or more resistor grids.

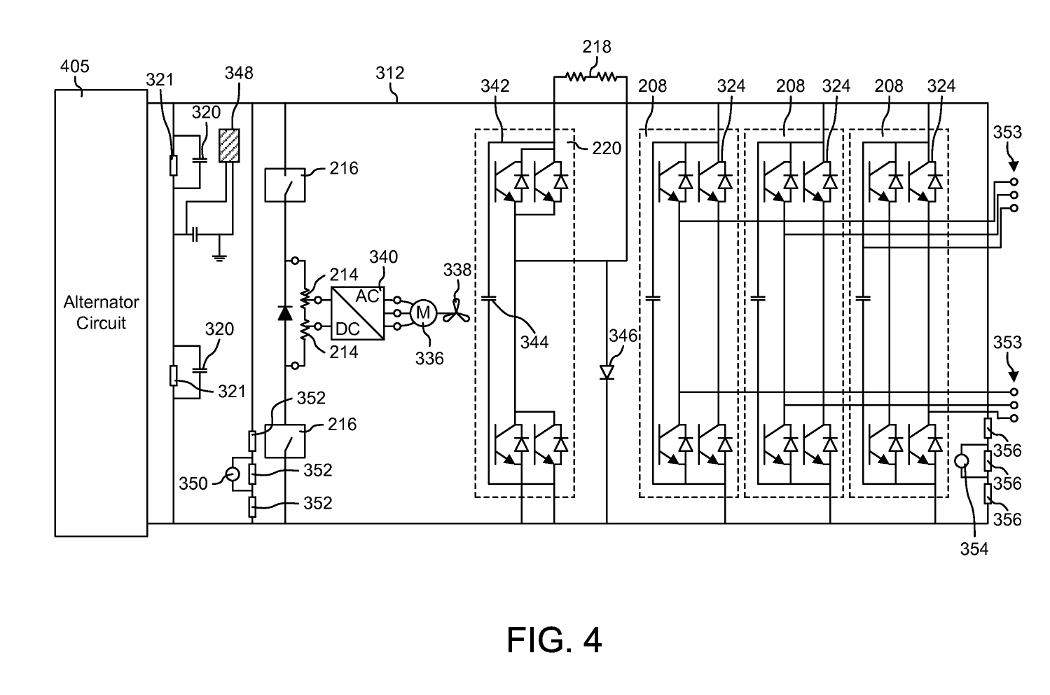

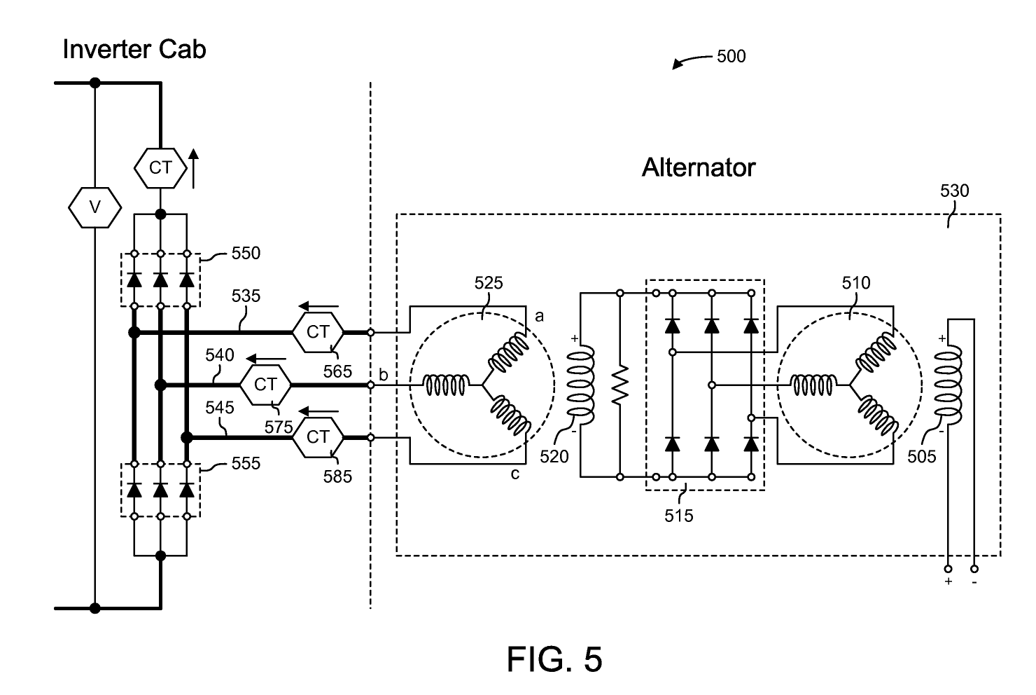

FIG. 4 illustrates a schematic diagram of an electric drive system for a mining vehicle according to an exemplary embodiment. Referring to both FIGS. 3 and 4, engine 202 is connected to generator 204 via an output drive shaft. Even though a direct connection to the output drive shaft is shown, other drive components, such as a transmission or other gear arrangements, may be utilized to couple the output of engine 202 to an alternator circuit 405. Alternator circuit 405 comprises generator 204 and rectifier 206. Generator 204 generates a multi-phase AC power signal which is transmitted to rectifier 206, which converts the AC power signal into a DC power output signal for use in powering one or more load devices of off-highway truck 101. Characteristics of alternator circuit 405, according to various exemplary embodiments, are described in further detail below with respect to FIGS. 5 through 20.

When power is supplied from the output of generator 204, rectifier 206 operates to provide rectification (e.g., full wave rectification) of each of the phases of the multi-phase alternating current. Rectifier 206 develops a voltage across a DC linkage or DC link 312. This DC link voltage is available at a first rail and a second rail of DC link 312. The first rail is typically at a first voltage and the second rail is typically at a second voltage during operation.

Either of the first and second voltages may be zero.

During operation, a voltage is developed across the first and second rails of DC link 312 by rectifier 206 and/or an inverter circuit 208. One or more capacitors 320 may be connected in parallel with one or more resistors 321 across DC link 312 to smooth the voltage V across the first and second rails of DC link 312. DC link 312 exhibits a DC link voltage, V, which can be measured by a voltage transducer 314, and a current, A, which can be measured by a current transducer 316, as shown in FIG. 3.

Inverter circuit 208 is connected in parallel with rectifier 206 and operates to transform the DC voltage V into variable frequency sinusoidal or non-sinusoidal AC power that drives, in this example, two drive motors 210. Any inverter may be used for the arrangement of the inverter circuit 208. In the example shown in FIG. 4, inverter circuit 208 includes three phase arrays of insulated-gate bipolar transistors (IGBT) 324 that are arranged in transistor pairs and that are configured to supply a 3-phase AC output to each drive motor 210.

Inverter circuit 208 can control the speed of the motors 210 by controlling the frequency and/or the pulse-width of the AC output. Drive motors 210 may be directly connected to drive wheels 108 or may power the final drives that power drive wheels 212. Final drives operate to reduce the rate of rotation and increase the torque between each drive motor 210 and each set of drive wheels 212.

When machine 100 operates in an electric braking mode, which is also known as electric retarding, less power is supplied from generator 204 to DC link 312. Because machine 100 is travelling at some non-zero speed, rotation of drive wheels 108 due to the kinetic energy of machine 100 will power drive motors 210. Drive motors 210, in this mode, act as generators by producing AC electrical power. Consumption or disposition of this electrical power will consume work and act to apply a counter-rotational torque on drive wheels 108, causing them to reduce their rotational speed, thus retarding the machine.

The generated AC electrical power can be converted into DC electrical power through inverter circuit 208 for eventual consumption or dissipation, for example, in the form of heat. In an illustrated embodiment, retard arrangement 213 dissipates such electrical power generated during retarding. Retard arrangement 213 can include any suitable arrangement that will operate to dissipate electrical power during retarding of the machine. In the exemplary embodiment shown in FIG. 4, retard arrangement 213 includes a first resistor grid 214 that is arranged to dissipate electrical energy at a fixed rate. Retard arrangement 213 also includes a second resistor grid 218, to which DC current is supplied at a selectively variable rate by use of a pulse width modulator (PWM) or chopper circuit 220. In this way, second resistor grid 218 dissipates electrical energy at a variable rate.

When machine 100 is to operate in a retarding mode, first resistor grid 214 is connected between the first and second rails of DC link 312 so that current may be passed therethrough. When machine 100 is being propelled, however, first resistor grid 214 is electrically isolated from DC link 312 by two contactors or bipolar automatic switches (BAS) 216. Each BAS 216 may include a pair of electrical contacts that are closed by an actuating mechanism, for example, a solenoid (not shown) or a coil creating a magnetic force that attracts the electric contacts to a closed position. BAS 216 may include appropriate electrical shielding and anti-spark features that can allow these items to operate repeatedly in a high voltage environment.

When machine 100 initiates retarding, it is desirable to close both BAS 216 within a relatively short period such that first resistor grid 214 is placed in circuit between the first and second DC rails to begin energy dissipation rapidly. Simultaneous actuation or actuation at about the same time, such as, within a few milliseconds, of the pair of BAS 216 may also advantageously avoid charging first resistor grid 214 and other circuit elements to the voltage present at the rails of DC link 312. The pair of BAS 216 also prevents exposure of each of BAS 216 or other components in the system to a large voltage difference (the voltage difference across DC link 312) for a prolonged period. A diode 334 may be disposed in parallel to first resistor grid 214 to reduce arcing across BAS 216, which also electrically isolates first resistor grid 214 from DC link 312 during a propel mode of operation.

When machine 100 is retarding, a large amount of heat can be produced by first resistor grid 214. Such energy, when converted to heat, may be removed from first resistor grid 214 to avoid an overheating condition. For this reason, a blower 338, driven by a motor 336, may operate to convectively cool first resistor grid 214. There are a number of different alternatives available for generating the power to drive motor 336. In this embodiment, a DC/AC inverter 340 is arranged to draw power from voltage-regulated locations across a portion of the first resistor grid 214. DC/AC inverter 340 may advantageously convert DC power from DC link 312 to 3-phase AC power that drives motor 336 when voltage is applied to first resistor grid 214 during retarding.

In the illustrated embodiment, BAS 216 are not arranged to modulate the amount of energy that is dissipated through first resistor grid 214. During retarding, however, machine 100 may have different energy dissipation requirements. This is because, among other things, the voltage V in DC link 312 may be controlled to be within a predetermined range. To meet such dissipation requirements, second resistor grid 218 can be exposed to a controlled current during retarding through action of chopper circuit 220. Chopper circuit 220 may have any appropriate configuration that will allow modulation of the current supplied to second resistor grid 218. In this embodiment, chopper circuit 220 includes an arrangement of transistors 342 that can, when actuated according to a desired frequency and/or duration, modulate the current passed to second resistor grid 218. This controls the amount of energy dissipated by second resistor grid 218 during retarding. Chopper circuit 220 may additionally include a capacitor 344 that is disposed between the first and second rails of DC link 312 and that regulates the voltage input to chopper circuit 220. A switched diode 346 may be connected between second resistor grid 218 and DC link 312 to protect against short circuit conditions in DC link 312 and to provide a device that can deactivate DC link 312, for example, during service.

The passage of current through second resistor grid 218 will also generate heat. Second resistor grid 218 may be cooled to dissipate the heat. In this embodiment, first and second resistor grids 214 and 218 may both be located within blower housing 116 for convective cooling when motor 336 and blower 338 are active.

The embodiment for a drive system shown in FIG. 4 includes other optional components that are discussed for the sake of completeness. In this exemplary embodiment, a leakage detector 348 is connected between the two resistors 321, in series with a capacitor 349, to the first and second rails of DC link 312. Leakage detector 348 detects any current leakage to ground from either of the first and second rails of DC link 312. In one embodiment, a first voltage indicator 350 may be connected between resistors 352 across the first and second rails of DC link 312. First voltage indicator 350 may be disposed between rectifier 206 and retard arrangement 213 such that a high voltage condition may be detected. In a similar fashion, a second voltage indicator 354 may be connected between resistors 356 across the first and second rails of DC link 312. Second voltage indicator 354 may be disposed between connection nodes 353 that connect to drive motors 210 and inverter circuit 208 to detect a voltage condition occurring during, for example, a bus bar fracture where DC link 312 is not continuous, in order to diagnose whether inverter circuit 208 is operating.

While various components have been described above according to exemplary embodiments for the sake of illustration, it should be appreciated that the systems herein may be utilized with machines having additional, fewer, and/or different components without departing from the teachings of the present disclosure.

In various exemplary embodiments, alternator circuit 405 may include various different types of power systems configured to provide power to components of a machine, such as a mining vehicle. Referring now to FIG. 5, a schematic diagram of a power system 500 is shown according to an exemplary embodiment. Power system 500 includes a three-phase AC synchronous generator. In some embodiments, system 500 may have a brushless, wound rotor. The generator has an output for each of three phases of alternating current being generated, i.e., a first phase output 535, a second phase output 540, and a third phase output 545. The rotor of the generator includes a rectifier assembly 515 that is connected to an exciter armature 510, both of which may rotate. Exciter armature 510 is energized by an excitation field produced by an excitation winding 505. Thus, the application of an excitation signal at the input to excitation winding 505 creates an excitation field to activate a generator field 520. Generator field 520, in turn, produces the output available at three leads of an output armature 525 of the generator, which may be stationary.

In the illustrated embodiment, rectifier assembly 515 includes a rotating exciter armature 510 that is connected to an array of rotating diodes. The three phase outputs 535, 540, and 545 of the generator, which are collectively considered the output of the generator, are connected to a rectifier circuit including a first rectifier module 550 and a second rectifier module 555. In some embodiments, the currents of three phase outputs 535, 540, and 545 may be measured using a first phase current transducer 565, a second phase current transducer 575, and a third phase current transducer 585, respectively. If one of the arrays of rotating diodes of rectifier assembly 515 fails, a greater current is required to develop a given voltage. Thus, the electric drive system tends to operate less efficiently when such a malfunction occurs.

The rectifier circuit converts the AC power supplied by the generator into DC power. In the example shown, the rectifier is a poly-phase diode bridge, and in particular is a three phase full bridge rectifier. The illustrated rectifier includes three parallel pairs of power diodes, each pair being associated with a given phase of the output of the generator. Each such diode pair includes two power diodes connected in series across a DC link, with the selected output of the generator providing a power input between each pair.

Power system 500 can experience some problems that can result in system inefficiency or failure and may require maintenance and/or costly downtime. For example, in the illustrated embodiment, the generator/alternator is enclosed within a housing 530, and the rectifier circuit is housed within a separate inverter cabinet. Three electrical cables transmit the three phase outputs 535, 540, and 545 of the generator to the rectifier circuit. In some instances, these cables may be damaged, and may require repair or replacement. In some embodiments, the inverter cabinet may house other components than the rectifier circuit, and may become crowded and constrict airflow, which may lead to temperature-related component failures.

Additionally, each of the phases of system 500 may carry a relatively large current, and may require fairly large and/or highly rated (e.g., expensive) components, such as diodes and/or capacitors (e.g., capacitors 320). The higher currents may lead to higher temperatures, increased risk of electrical shorts and/or arc damage, and/or other issues. The larger components may be more expensive and/or difficult to replace.

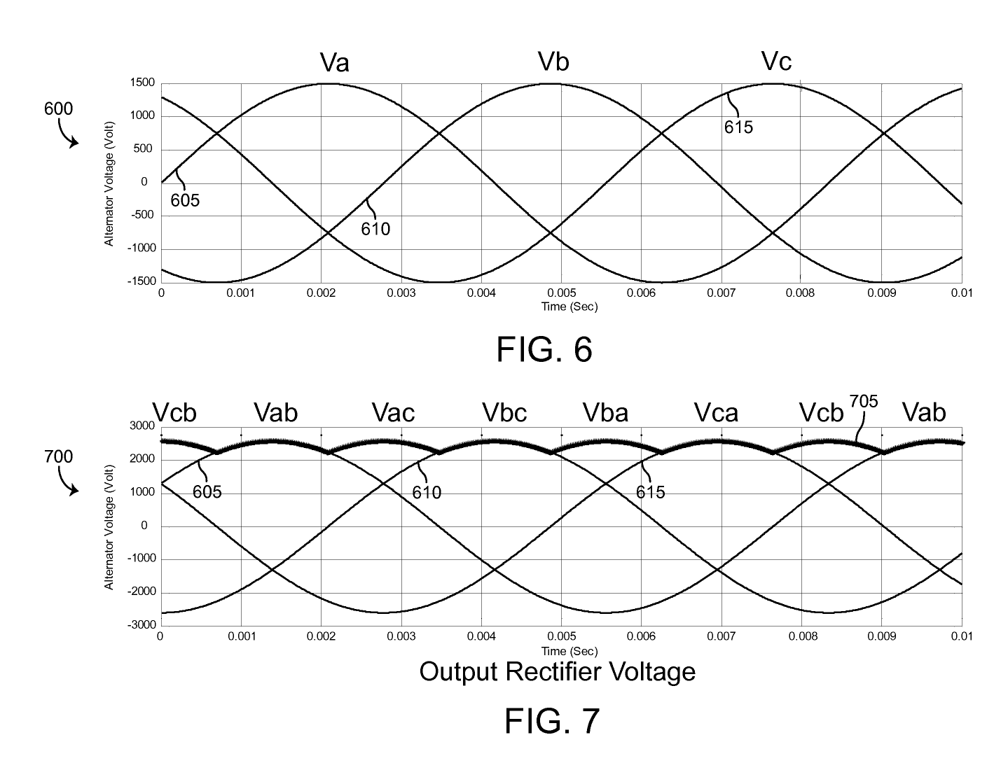

Further, the combined DC power output of the rectifier circuit from the combination of the three phase outputs 535, 540, and 545 may experience a ripple voltage, or instability in the DC output voltage. FIG. 6 shows a graph 600 illustrating a voltage waveform of each of the three phases of power system 500 shown in FIG. 5 according to an exemplary embodiment. In one embodiment, a first phase waveform 605 may correspond to first phase output 535, a second phase waveform 610 may correspond to second phase output 540, and a third phase waveform 615 may correspond to third phase output 545.

FIG. 7 shows a graph 700 illustrating a DC output voltage 705 of the rectifier circuit of power system 500 shown in FIG. 5 according to an exemplary embodiment. As can be seen in graph 700, DC output voltage 705 is not steady at a single value, but rather varies somewhat as the underlying waveforms 605, 610, and 615 upon which DC output voltage 705 is based vary. DC output voltage 705 includes six pulses for each full cycle of the AC input from the generator.

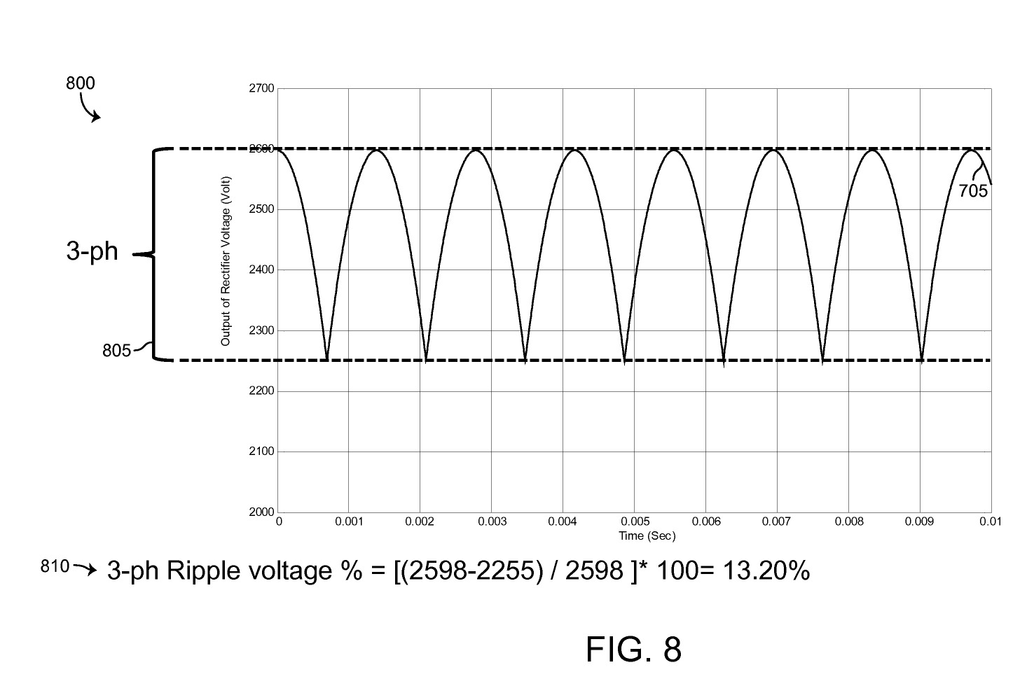

FIG. 8 shows a graph 800 focused on a portion of the voltage range shown in graph 700 of FIG. 7, illustrating the variation in DC output voltage 705 in greater detail according to an exemplary embodiment. Graph 800 illustrates that, in this exemplary embodiment, DC output voltage 705 fluctuates within a ripple envelope 805 between 2,598 volts and 2,255 volts. Thus, in the illustrated example, the three-phase ripple voltage percentage 810, or DC output voltage 705 fluctuation, is approximately 13.20% of the maximum of DC output voltage 705. In some instances, this variation may cause components to operate with reduced efficiency, lead components to operate outside of rated tolerances, lead to component failures, and/or cause other types of issues.

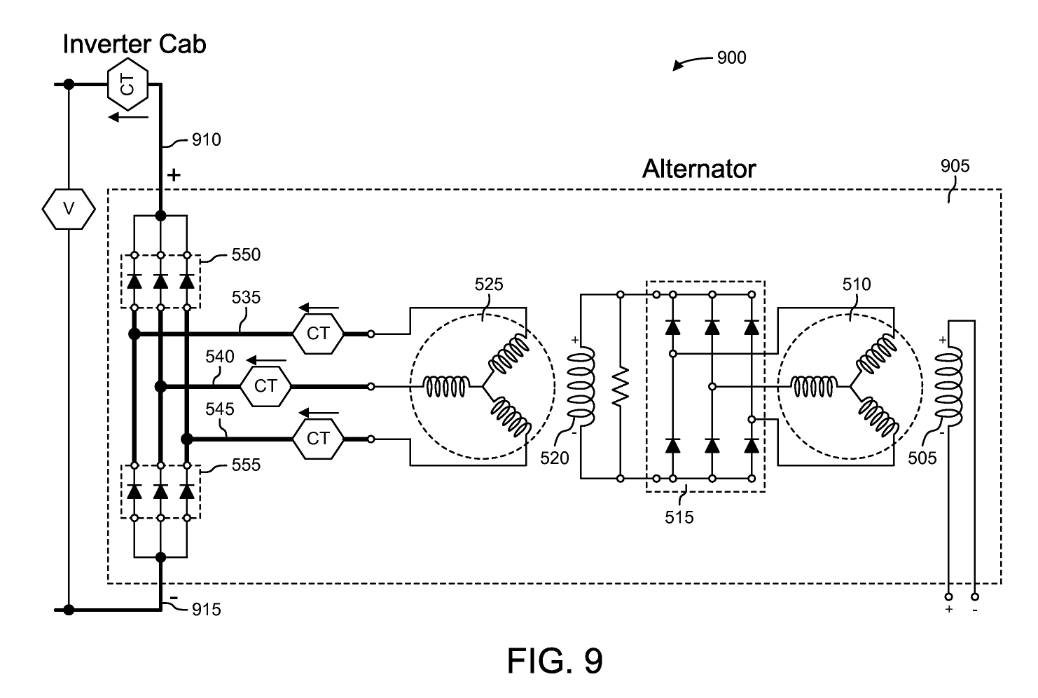

In some embodiments, the rectifier circuit may be relocated and paired with the generator/alternator. FIG. 9 illustrates a schematic diagram of a power system 900 for a mining vehicle having a generator and a rectifier in a same housing or in housings coupled to one another according to an exemplary embodiment. In the illustrated embodiment, the rectifier circuit has been moved so that it is enclosed within a common housing 905 with the generator. In other embodiments, the rectifier circuit and the generator may be enclosed within separate housings that are directly coupled to one another, such as with fasteners. By enclosing the generator and rectifier within a common housing, or within housings coupled to one another, this may reduce or eliminate the risk of damage to the cables carrying the three phase outputs 535, 540, and 545 of the generator. Further, in some embodiments, these cables may be shorter than in the embodiment shown in FIG. 5, reducing a power loss across a length of the cables. Moving the rectifier circuit out of the inverter cabinet may also help increase airflow through that cabinet, which may reduce the number of temperature-related component failures. This may also allow for reconfiguration of some components in the inverter cabinet, such as capacitors 320. In some embodiments, removing the rectifier circuit from the inverter cabinet may allow some bus bars in the cabinet to be removed.

In the illustrated embodiment, the number of cables extending from the generator/rectifier housing(s) to the inverter cabinet is reduced from three to two, a positive DC output cable 910 and a negative DC output cable 915. These cables may be exposed to outside forces, and may be designed to withstand such forces. As a result, the cables may be more expensive and/or higher grade than cables enclosed within housings. By reducing the number of cables from three to two, this may decrease a cost associated with the cables.

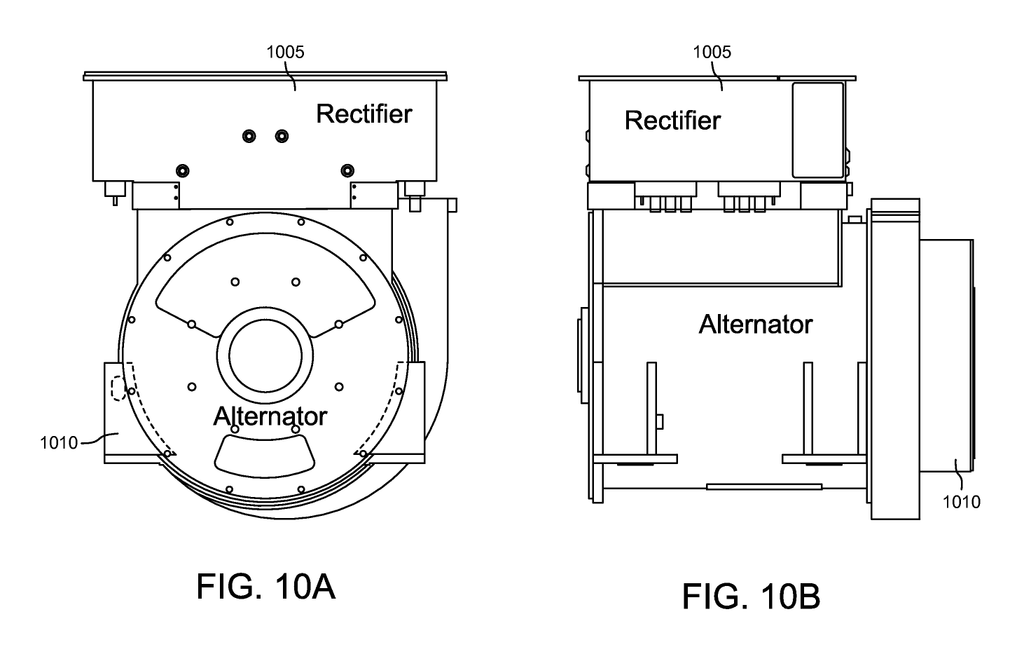

FIGS. 10A and 10B illustrate front and side views, respectively, of power system 900 of FIG. 9 according to one illustrative embodiment. In the illustrated embodiment, a rectifier circuit 1005 is enclosed within a separate housing from an alternator/generator 1010 that is fastened to a top of the alternator/generator housing. The housings may be coupled together in any manner, such as by using fasteners (e.g., bolts, rivets, screws, etc.). The cables carrying the three phase outputs 535, 540, and 545 may extend up from alternator/generator 1010 to the rectifier circuit 1005 housing, and the DC output of rectifier circuit 1005 may be transmitted away from rectifier circuit 1005 via two cables protruding from the housing of rectifier circuit 1005.

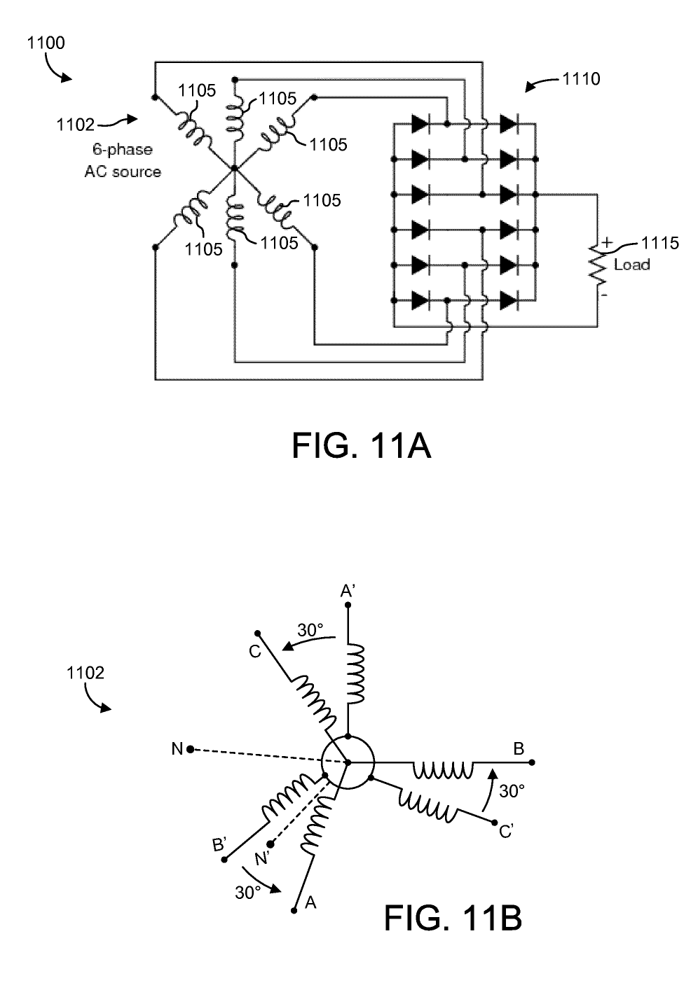

In some embodiments, the power system may additionally or alternatively utilize a generator circuit configured to generate AC power distributed amongst at least six phases, and a rectifier configured to generate a DC output power signal having at least twelve pulses for each full wave/cycle of the AC power signal from the generator. FIG. 11A shows a schematic illustration of a portion of a six-phase synchronous generator circuit 1100 according to an exemplary embodiment. In the illustrated embodiment, generator circuit 1100 includes a six-phase output armature 1102 including six windings 1105, each associated with a separate output phase of generator circuit 1100. The output phases are transmitted to a rectifier circuit 1110, which, in the illustrated embodiment, is a full-wave diode bridge including twelve diode devices. Rectifier circuit 1110 is configured to generate a DC output power signal configured to provide power to a load device 1115 electrically coupled to rectifier circuit 1110 (e.g., connected across rectifier circuit 1110). In some embodiments, rectifier circuit 1110 is configured to generate at least twelve pulses for each full cycle of the AC input from six-phase output armature 1102.

FIG. 11B illustrates a winding configuration of six-phase synchronous generator circuit 1100 shown in FIG. 11A according to an exemplary embodiment. In the illustrated embodiment, three of windings 1105 are connected to one another in a wye configuration at a first common terminal, and the other three of windings 1105 are connected to one another in a wye configuration at a second common terminal that is different from the first common terminal (e.g., the same as a three phase alternator with two wye connection windings, but they are not in parallel). In some embodiments, the voltage on a winding 1105 of the second set of windings may be substantially the same as the voltage on a corresponding winding 1105 of the first set of windings, but may be shifted in phase by a predetermined phase difference (e.g., thirty degrees).

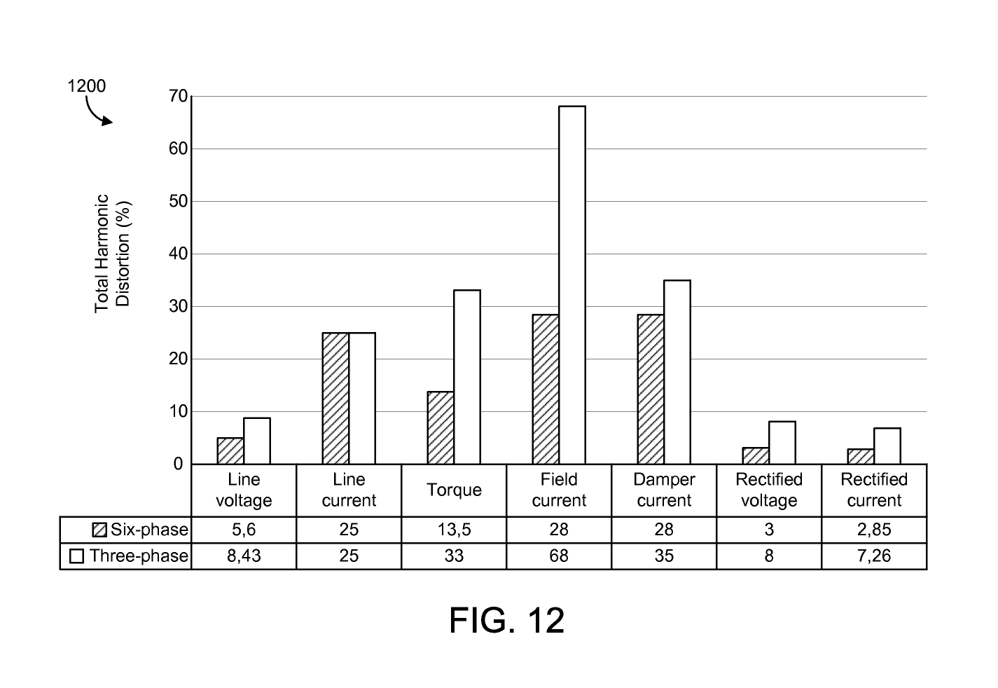

FIG. 12 is a graph 1200 illustrating total harmonic distortion (THD) in various characteristics of a three-phase power system and a six-phase power system according to an exemplary embodiment. As can be seen in the graph, the THD across the categories is generally lower, and in some instances substantially lower, in the six-phase power system than the three-phase system. For example, THD for torque, field current, and rectified voltage and current for the six-phase system are all substantially lower than the corresponding values for the three-phase system. A six-phase system may achieve increased alternator/generator efficiency by decreasing heating at the rotor and/or stator, increased bearing performance (e.g., reduced bearing failures) by reducing torque pulsation, increased alternator life time by increasing alternator efficiency, a decreased/less expensive DC capacitor filter by reducing a DC ripple voltage, and/or various other improvements as compared to the three-phase system.

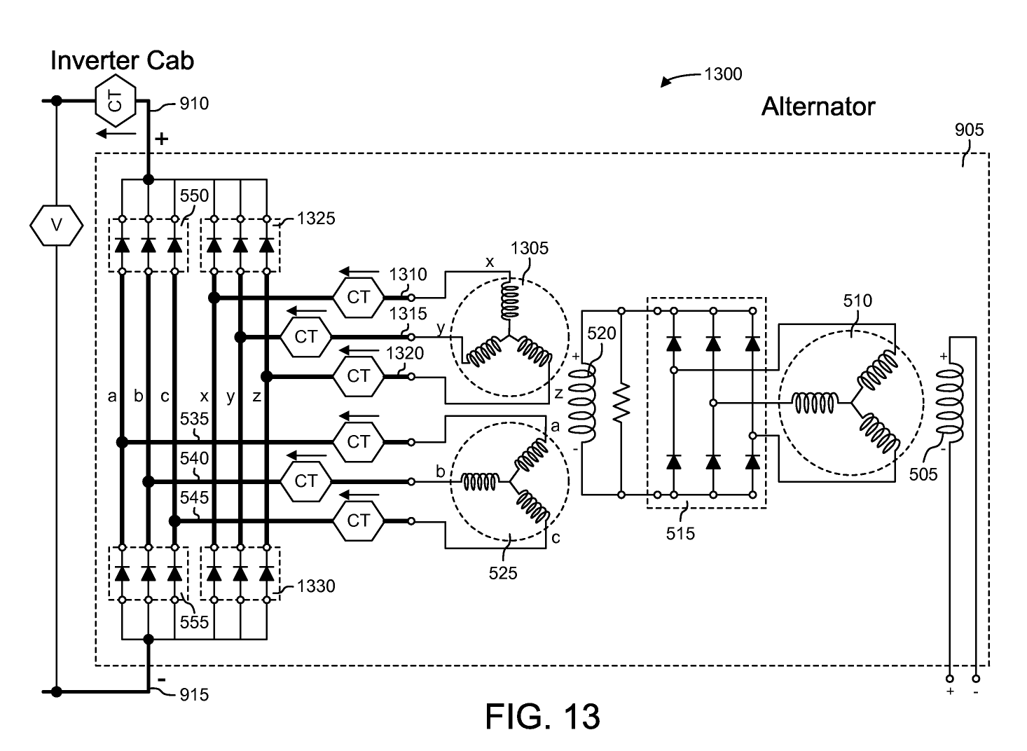

FIG. 13 shows a schematic diagram of a six-phase power system 1300 for a mining vehicle according to an exemplary embodiment. In addition to various elements described above with respect to FIGS. 5 and 9, six-phase power system 1300 includes a second output armature 1305 including a second set of windings. The combination of second output armature 1305 and output armature 525 is configured to generate an AC power signal distributed across six phases, first phase output 535, second phase output 540, third phase output 545, fourth phase output 1310, fifth phase output 1315, and sixth phase output 1320. The six-phase AC power signal is transmitted to a rectifier circuit configured to generate a DC output power signal having twelve pulses for each cycle of the AC signal. In the illustrated implementation, the rectifier circuit includes a total of twelve diodes distributed across first rectifier module 550, second rectifier module 555, a third rectifier module 1325, and a fourth rectifier module 1330 (e.g., a pair of diodes for each phase). In some embodiments, the alternator/generator lamination may be modified to increase a number of slots (e.g., increase from 72 slots to 96 slots). As compared to system 500, system 1300 may be able to achieve one or more of the following: smaller diodes and/or capacitors (e.g., due a smaller rated current), a reduced rotor and/or stator heating (e.g., due to a reduced total harmonic distortion across one or more characteristics, such as current and/or voltage characteristics), an increased life time of the alternator/generator bearings by reducing torque pulsation, a reduced fuel consumption in the engine due to increasing alternator efficiency, a reduced DC link ripple voltage and/or increased inverter performance, and/or a higher reliability (e.g., due to an increased number of alternator/generator phases). In some implementations, reduced heat may allow less and/or smaller blower motors to be used to cool components, such as capacitors.

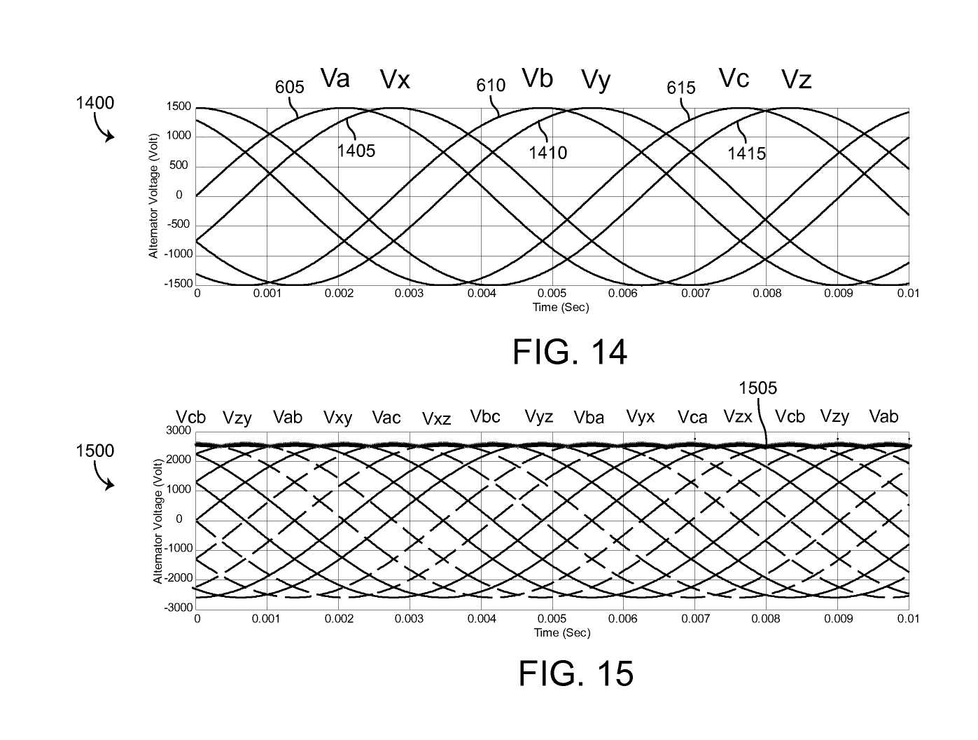

FIG. 14 is a graph 1400 illustrating a voltage waveform of each of the six phases of six-phase power system 1300 shown in FIG. 13 according to an exemplary embodiment. Graph 1400 includes first phase waveform 605, second phase waveform 610, and third phase waveform 615. Graph 1400 also includes a fourth phase waveform 1405 corresponding to fourth phase output 1310, a fifth phase waveform 1410 corresponding to fifth phase output 1315, and a sixth phase waveform 1415 corresponding to sixth phase output 1320.

FIG. 15 shows a graph 1500 illustrating a DC output voltage 1505 of the rectifier circuit of six-phase power system 1300 shown in FIG. 13 according to an exemplary embodiment. As can be seen by comparing graph 1500 to graph 700, the ripple voltage associated with DC output voltage 1505 is substantially lower than the ripple voltage associated with DC output voltage 705 of system 500.

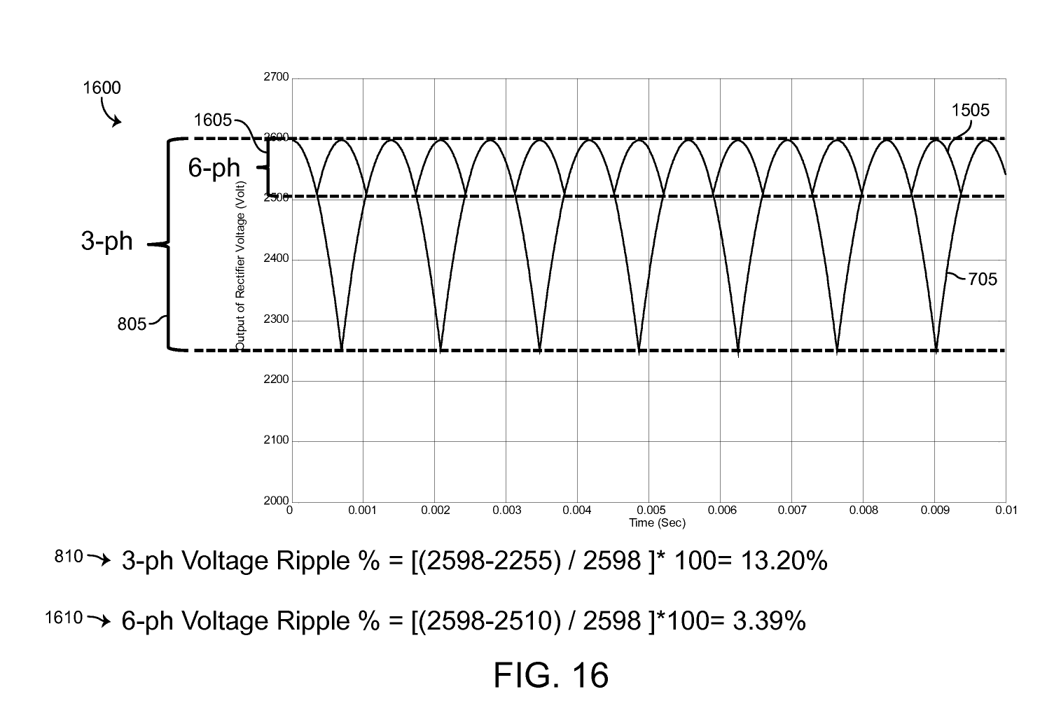

FIG. 16 shows a graph 1600 focused on a portion of the voltage range shown in graph 1500 of FIG. 15, illustrating the variation in DC output voltage 1505 in greater detail according to an exemplary embodiment. Graph 1600 illustrates that, in this exemplary embodiment, DC output voltage 1505 fluctuates within a ripple envelope 1605 between 2,598 volts and 2,510 volts. Thus, in the illustrated example, the ripple voltage, or DC output voltage 1505 fluctuation, is approximately 3.39% of the maximum of DC output voltage 1505. FIG. 16 also illustrates the ripple voltage associated with DC output voltage 705 for purposes of comparison. As can be seen in FIG. 16, the six-phase ripple voltage percentage 1610 associated with six-phase power system 1300, in the illustrated exemplary embodiment, is substantially lower than that associated with three-phase power system 500 (3.39% of the maximum voltage, as compared to 13.20%). The reduced ripple voltage may allow for more reliable and efficient operation of load components and/or power system components, greater fuel efficiency, less failures, and/or other benefits.

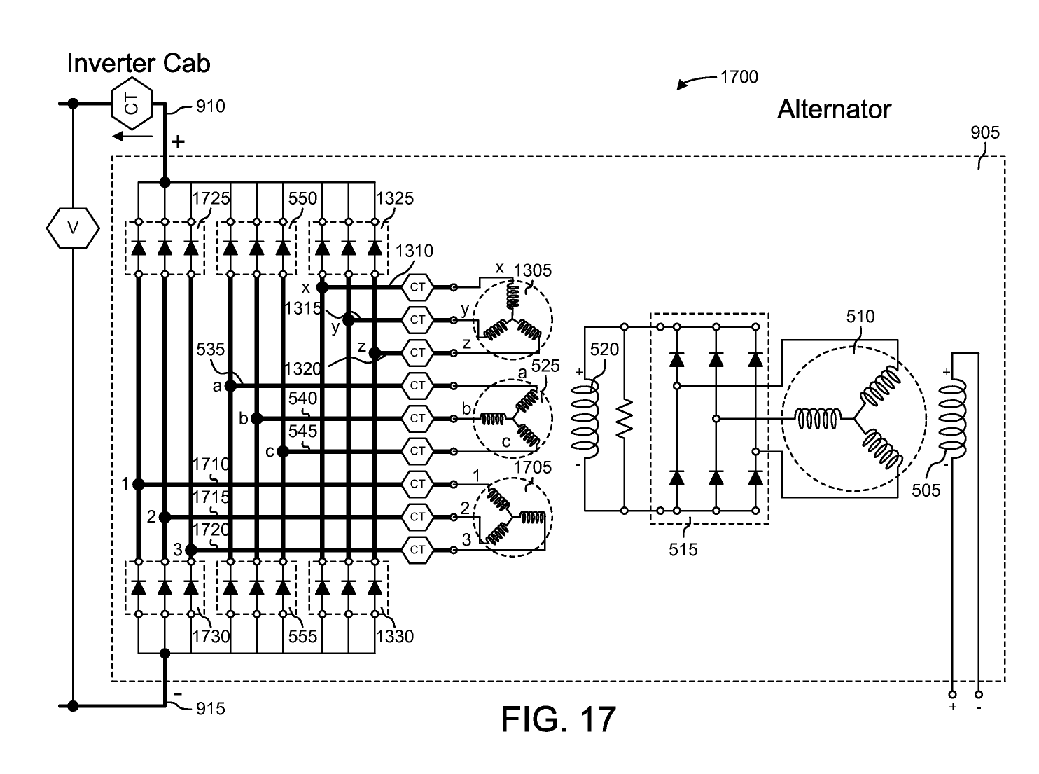

In some embodiments, the power system may be configured to distribute AC power across greater than six phases and/or generate a DC output signal having more than 12 pulses for each full cycle of the AC signal. FIG. 17 shows a schematic diagram of a nine-phase power system 1700 for a mining vehicle according to an exemplary embodiment. In addition to various elements described above with respect to FIGS. 5, 9, and/or 13, nine-phase power system 1700 includes a third output armature 1705 including a third set of windings. In some implementations, third output armature 1705 may include three windings connected at a common terminal in a wye configuration, and the common terminal of third output armature 1705 may be different from the common terminals of output armature 525 and second output armature 1305. In some embodiments, windings of each of output armatures 525, 1305, and 1705 may be shifted by a predetermined phase difference (e.g., twenty degrees) from corresponding windings of one or more of the other armatures. The combination of third output armature 1705, second output armature 1305, and output armature 525 is configured to generate an AC power signal distributed across nine phases, first phase output 535, second phase output 540, third phase output 545, fourth phase output 1310, fifth phase output 1315, sixth phase output 1320, seventh phase output 1710, eighth phase output 1715, and ninth phase output 1720. The nine-phase AC power signal is transmitted to a rectifier circuit configured to generate a DC output power signal having eighteen pulses for each cycle of the AC signal. In the illustrated implementation, the rectifier circuit includes a total of eighteen diodes distributed across first rectifier module 550, second rectifier module 555, third rectifier module 1325, fourth rectifier module 1330, a fifth rectifier module 1725, and a sixth rectifier module 1730 (e.g., a pair of diodes for each phase). In some embodiments, the use of nine phases may provide further improvements in various characteristics of power system 1700, such as reduced total harmonic distortion, reduced current/voltage, reduced heat, etc. In some embodiments, the alternator of system 1700 may have a same lamination (e.g., 72 slots) as a lamination of system 500.

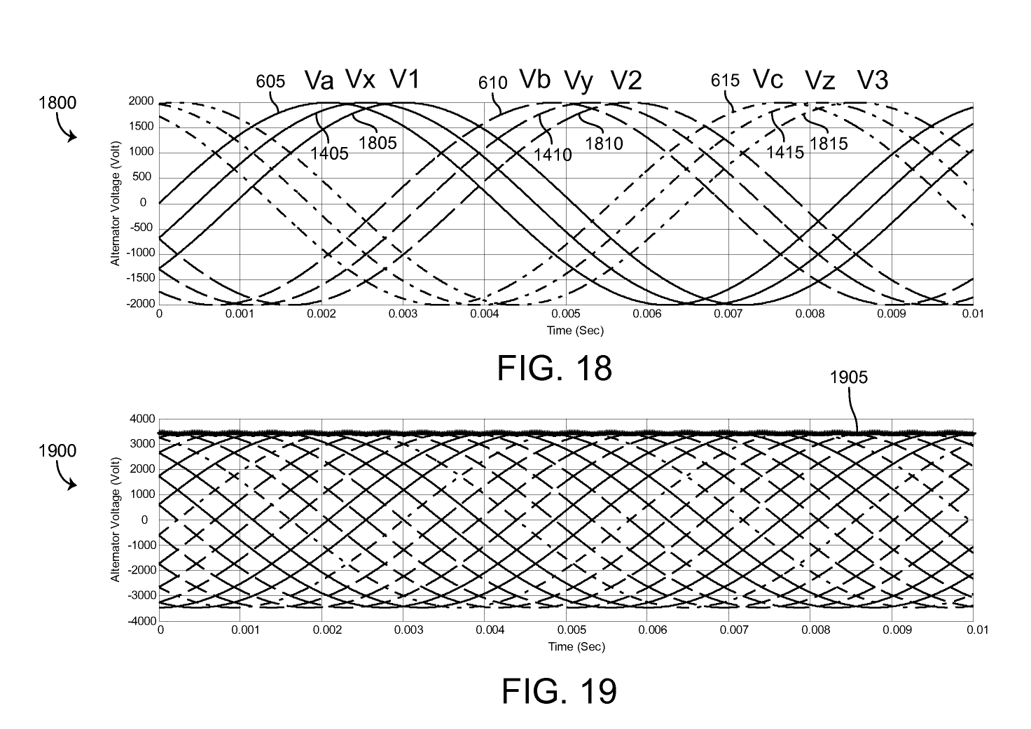

FIG. 18 is a graph 1800 illustrating a voltage waveform of each of the nine phases of nine-phase power system 1700 shown in FIG. 17 according to an exemplary embodiment. Graph 1800 includes first phase waveform 605, second phase waveform 610, third phase waveform 615, fourth phase waveform 1405, a fifth phase waveform 1410, and sixth phase waveform 1415. Graph 1800 also includes a seventh phase waveform 1805 corresponding to seventh phase output 1710, an eighth phase waveform 1810 corresponding to eighth phase output 1715, and a ninth phase waveform 1815 corresponding to ninth phase output 1720.

FIG. 19 shows a graph 1900 illustrating a DC output voltage 1905 of the rectifier circuit of nine-phase power system 1800 shown in FIG. 17 according to an exemplary embodiment. As can be seen by comparing graph 1800 to graphs 700 and 1500, the ripple voltage associated with DC output voltage 1905 is substantially lower than the ripple voltage associated with DC output voltage 705 of system 500, and is also lower than the ripple voltage associated with DC output voltage 1505 of system 1300.

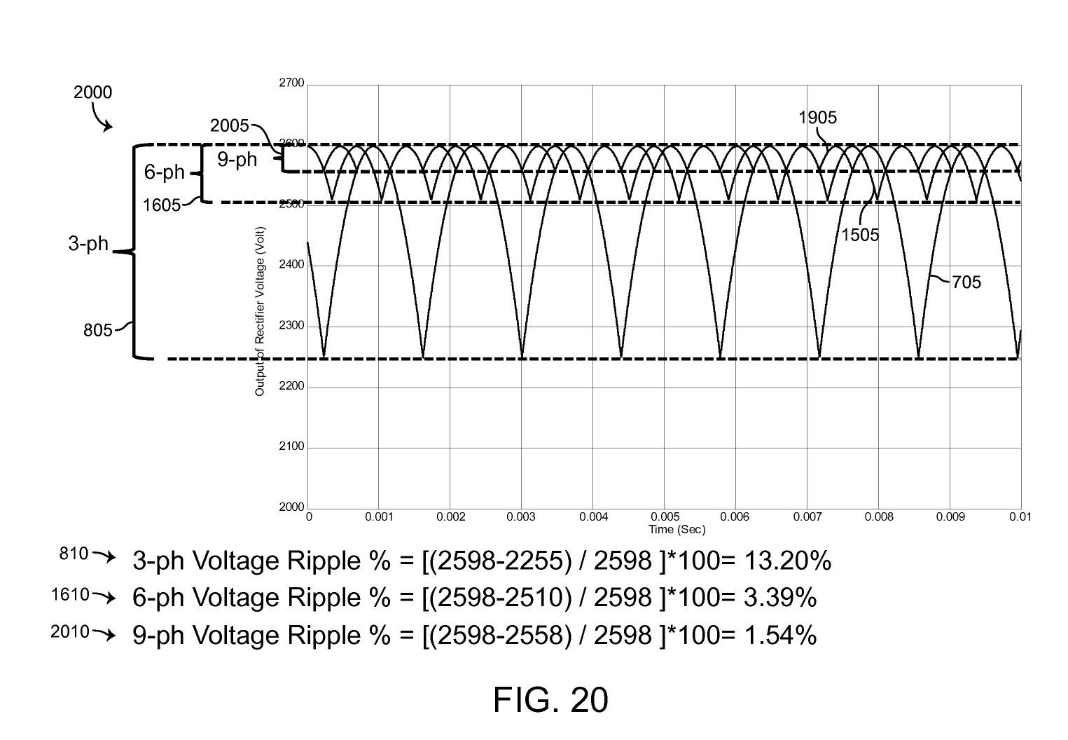

FIG. 20 shows a graph 2000 focused on a portion of the voltage range shown in graph 1900 of FIG. 19, illustrating the variation in DC output voltage 1905 in greater detail according to an exemplary embodiment. Graph 2000 illustrates that, in this exemplary embodiment, DC output voltage 1905 fluctuates within a ripple envelope 2005 between 2,598 volts and 2,558 volts. Thus, in the illustrated example, the nine-phase ripple voltage percentage 2010, or DC output voltage 1905 fluctuation, is approximately 1.54% of the maximum of DC output voltage 1905. FIG. 20 also illustrates the ripple voltage associated with DC output voltages 705 and 1505 for purposes of comparison. As can be seen in FIG. 20, the nine-phase ripple voltage percentage 2010 associated with nine-phase power system 1700, in the illustrated exemplary embodiment, is substantially lower than that associated with three-phase power system 500 (1.54% of the maximum voltage, as compared to 13.20%), and is also lower than that associated with six-phase power system 1300 (1.54% as compared to 3.39%). The reduced ripple voltage may further increase the reliability and efficiency of the system. In some embodiments, the increased number of components in nine-phase power system 1700 may cause it to have a higher initial cost than six-phase power system 1300.

### INDUSTRIAL APPLICABILITY

The disclosed power systems may be implemented in any vehicle having an electric power system where components are powered using generators/alternators and rectifier circuits. In some specific exemplary embodiments, the disclosed power systems may be implemented in a mining truck (e.g., such as that illustrated in FIGS. 1-3). In various exemplary embodiments, the power systems may be used in various types of vehicles, such as load hauling mining trucks, electric/hybrid mining shovels, draglines, and/or other types of heavy equipment. The power systems may be used to improve reliability of the machines to help keep them available to perform tasks, such as moving material around, to, and/or from a mining site, and to reduce a cost and/or time associated with maintenance of such machines.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials and components, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

Although the description and/or figures may describe a specific order of method steps, the order of the steps may differ from what is described. Also two or more steps may be performed concurrently or with partial concurrence. Such variation will depend on the software and hardware systems chosen and on designer choice. All such variations are within the scope of the disclosure.

What is claimed is:

1. A power system for a mining vehicle, the power system comprising:
a synchronous generator circuit configured to generate an alternating current (AC) power signal distributed across at least six phases; and
a rectifier circuit comprising at least twelve diode devices and configured to receive the AC power signal distributed across the at least six phases from the synchronous generator circuit and generate a direct current (DC) power output signal, the DC power output signal comprising at least twelve pulses for a single wave of the AC power signal received from the synchronous generator circuit, the rectifier circuit configured to output the DC power output signal for use in powering a load device of the mining vehicle.

2. The power system of claim 1, further comprising:
a first housing configured to enclose the synchronous generator circuit; and
a second housing configured to enclose the rectifier circuit, the second housing directly coupled to the first housing.

3. The power system of claim 2, further comprising two cables protruding from the second housing and configured to electrically couple the rectifier circuit to one or more devices within an inverter cabinet of the mining vehicle, the two cables configured to transmit the DC power output signal from the rectifier circuit to the one or more devices within the inverter cabinet.

4. The power system of claim 1, further comprising a single housing configured to enclose both the synchronous generator circuit and the rectifier circuit.

5. The power system of claim 1, the synchronous generator circuit configured to distribute the AC power signal across six phases, the rectifier circuit comprising twelve diode devices, and the DC power output signal comprising twelve pulses for the single wave of the AC power signal received from the synchronous generator circuit.

6. The power system of claim 5, the synchronous generator circuit comprising:
a first three-phase alternator module comprising a first set of three windings connected at a first common terminal in a wye configuration; and
a second three-phase alternator module comprising a second set of three windings connected at a second common terminal in the wye configuration, the second common terminal different from the first common terminal, each winding in the second set of three windings having a phase offset of thirty degrees from a winding in the first set of three windings.

7. The power system of claim 6, wherein a lamination of the synchronous generator circuit comprises 96 slots.

8. The power system of claim 5, wherein the rectifier circuit is configured to generate the DC power output signal with a ripple voltage of less than five percent of a maximum voltage of the DC power output signal.

9. The power system of claim 1, the synchronous generator circuit configured to distribute the AC power signal across nine phases, the rectifier circuit comprising eighteen diode devices, and the DC power output signal comprising eighteen pulses for the single wave of the AC power signal received from the synchronous generator circuit.

10. The power system of claim 9, the synchronous generator circuit comprising:
a first three-phase alternator module comprising a first set of three windings connected at a first common terminal in a wye configuration;
a second three-phase alternator module comprising a second set of three windings connected at a second common terminal in the wye configuration; and
a third three-phase alternator module comprising a third set of three windings connected at a third common terminal in the wye configuration;
the first common terminal, the second common terminal, and the third common terminal comprising different terminals, each winding in the second set of three windings having a phase offset of twenty degrees from a winding in the first set of three windings, each winding in the third set of three windings having a phase offset of twenty degrees from a winding in the second set of three windings.

11. The power system of claim 10, wherein a lamination of the synchronous generator circuit comprises 72 slots.

12. The power system of claim 9, wherein the rectifier circuit is configured to generate the DC power output signal with a ripple voltage of less than two percent of a maximum voltage of the DC power output signal.

13. A mining vehicle comprising:
at least one load device configured to perform one or more functions of the mining vehicle;
a synchronous generator circuit configured to generate an alternating current (AC) power signal distributed across at least six phases; and
a rectifier circuit comprising at least twelve diode devices and configured to receive the AC power signal distributed across the at least six phases from the synchronous generator circuit and generate a direct current (DC) power output signal, the DC power output signal comprising at least twelve pulses for a single wave of the AC power signal received from the synchronous generator circuit, the rectifier circuit configured to output the DC power output signal for use in powering the at least one load device.

14. The mining vehicle of claim 13, further comprising:
a first housing configured to enclose the synchronous generator circuit; and
a second housing configured to enclose the rectifier circuit, the second housing directly coupled to the first housing.

15. The mining vehicle of claim 14, further comprising two cables protruding from the second housing and configured to electrically couple the rectifier circuit to one or more devices within an inverter cabinet of the mining vehicle, the two cables configured to transmit the DC power output signal from the rectifier circuit to the one or more devices within the inverter cabinet.

16. The mining vehicle of claim 13, further comprising a single housing configured to enclose both the synchronous generator circuit and the rectifier circuit.

17. The mining vehicle of claim 13, the synchronous generator circuit configured to distribute the AC power signal across six phases, the rectifier circuit comprising twelve diode devices, and the DC power output signal comprising twelve pulses for the single wave of the AC power signal received from the synchronous generator circuit.

18. The mining vehicle of claim 17, the synchronous generator circuit comprising:
a first three-phase alternator module comprising a first set of three windings connected at a first common terminal in a wye configuration; and
a second three-phase alternator module comprising a second set of three windings connected at a second common terminal in the wye configuration, the second common terminal different from the first common terminal, each winding in the second set of three windings having a phase offset of thirty degrees from a winding in the first set of three windings.

19. The mining vehicle of claim 17, wherein the rectifier circuit is configured to generate the DC power output signal with a ripple voltage of less than five percent of a maximum voltage of the DC power output signal.

20. The mining vehicle of claim 13, the synchronous generator circuit configured to distribute the AC power signal across nine phases, the rectifier circuit comprising eighteen diode devices, and the DC power output signal comprising eighteen pulses for the single wave of the AC power signal received from the synchronous generator circuit.

21. The mining vehicle of claim 20, wherein the rectifier circuit is configured to generate the DC power output signal with a ripple voltage of less than two percent of a maximum voltage of the DC power output signal.

22. A power system for a mining vehicle, the power system comprising:
a synchronous generator circuit configured to generate an alternating current (AC) power signal distributed across six phases, the synchronous generator circuit comprising:
a first three-phase alternator module comprising a first set of three windings connected at a first common terminal in a wye configuration; and
a second three-phase alternator module comprising a second set of three windings connected at a second common terminal in the wye configuration, the second common terminal different from the first common terminal, each winding in the second set of three windings having a predetermined phase offset from a winding in the first set of three windings; and
a rectifier circuit comprising twelve diode devices and configured to receive the AC power signal distributed across the six phases from the synchronous generator circuit and generate a direct current (DC) power output signal, the DC power output signal comprising twelve pulses for a single wave of the AC power signal received from the synchronous generator circuit, the rectifier circuit configured to output the DC power output signal for use in powering one or more drive motors of the mining vehicle.

23. The power system of claim 22, further comprising:
a first housing configured to enclose the synchronous generator circuit;
a second housing configured to enclose the rectifier circuit, the second housing directly coupled to the first housing; and
two cables protruding from the second housing and configured to electrically couple the rectifier circuit to one or more devices within an inverter cabinet of the mining vehicle, the two cables configured to transmit the DC power output signal from the rectifier circuit to the one or more devices within the inverter cabinet.
